(19) United States
(12) Patent Application Publication
(10) Pub. No.: US 2010/0274595 A1
(43) Pub. Date: Oct. 28, 2010

(54) Ticket Management System and Method using Pre-Sales Keys

(75) Inventor: Philip Goodpasture, Richmond, VA (US)

Correspondence Address: Thomas F. Bergert;c/o WILLIAMS MULLEN IP docketing, 222 CENTRAL PARK AVENUE, SUITE 1700, VIRGINIA BEACH, VA, 23462, US

(73) Assignee: Ticket Traffic, LLC

(21) Appl. No.: 12/830,467

(22) Filed: Jul. 6, 2010

Related U.S. Application Data
(63) Continuation-in-part of application No. 11/728,348, filed on Mar. 26, 2007.
(60) Provisional application No. 60/785,436, filed on Mar. 24, 2006.

(51) Int. Cl. G06Q 10/00

(52) U.S. Cl. 705/5

(57) ABSTRACT

A ticket management system and method drives customer traffic in pre-ticket sales activities by issuing keys to potential ticket purchasers prior to the beginning of ticket sales for an event. Upon reading a key, the present invention provides for the issuance of one or more ticket opportunities to the potential ticket purchaser who has presented the key. Keys can be obtained online or in person at retail establishments, for example. By offering keys for ticket opportunities, retailers and event sponsors can generate foot traffic, Internet traffic and visibility for their commercial offerings. The present invention can be implemented, in one embodiment, with an electronic ticket managing system and a computer such as a retail kiosk, for example.

### REFERENCE TO RELATED APPLICATIONS

This application claims the benefit of U.S. utility application Ser. No. 11/728,348, filed Mar. 26, 2007, and entitled, “Distributed System and Method for Event Ticket Management and Delivery,” which claims the benefit of U.S. provisional patent application Ser. No. 60/785,436, filed Mar. 24, 2006 and entitled “Ticket Kiosks and Method of Ticket Delivery,” the disclosures of which are incorporated herein by reference.

### FIELD OF THE INVENTION

The present invention relates to ticket management, and more particularly to a ticket management system and method that drives customer traffic in pre-sales activities.

### BACKGROUND AND SUMMARY OF THE INVENTION

Ticket management and distribution for events such as concerts and sporting events is complicated. Depending upon the nature of the event, a promoter working with or without a performer/artist seeks to establish dates, times and locations for one or more events. Once scheduling is established, there is a need for ticket generation, marketing and sales in order to maximize the attendance and resulting revenues from the event. If ticketing management is flawed, either through poor promotion, poor ticket request processing, poor payment processing or poor distribution, the promoter, sponsor(s), venue and performers all suffer.

Traditionally, tickets have been purchased in person at the event venue, ticket box offices or distributed retail outlets. Tickets have also been purchased using the telephone, whereupon a ticket agent assists the purchaser in buying the tickets and then mails the tickets to the purchaser's desired address. Recently, it has become possible for ticket purchasers to buy tickets online and receive the printed tickets in the mail.

Unfortunately, such traditional efforts have failed in adequately managing the interests of all parties involved in the event process. For example, there can be significant selling opportunities available to marketers and event sponsors from the time tickets go on sale up until the day of the event. If tickets are purchased over the phone or online and mailed to the purchaser, the only opportunity to market to the buyer may be in mailing supplemental advertisements and/or coupons with the physical tickets. For this and other reasons, there is a need for a ticket management and delivery system that assists marketers, promoters and event sponsors in marketing, cross-selling and up-selling to ticket purchasers.

The present invention provides, in part, a ticket management system and method that accommodates distributed ticket delivery by enabling ticket purchasers to select from among a plurality of distribution options. In addition to physical mailing, the present invention provides for electronic transmission of tickets directly to purchasers or directly to remote kiosks or stations for pick up. The remote stations or kiosks can be affiliated with sponsors and/or event promoters, for example, and can provide additional sales opportunities to the ticket purchasers.

In addition, the present invention can assist in driving customer traffic prior to ticket sales by issuing keys to potential ticket purchasers. The keys can be delivered online or can be delivered in person such as when an individual physically visits a retail store acting as a key distributor, for example. Upon reading a key, the present invention provides for the issuance of one or more ticket opportunities to the potential ticket purchaser who has presented the key. Ticket opportunities can take a variety of forms, including discounted tickets, preferred seating, preferred purchase opportunities, limited availability amenities and other types of opportunities. By offering keys for ticket opportunities, retailers and event sponsors can generate foot traffic, Internet traffic and visibility for their commercial offerings.

### BRIEF DESCRIPTION OF THE DRAWINGS

FIG. 1 is an example schematic diagram illustrating the ticket management and delivery system of the present invention.

FIG. 2 is a representative flow chart illustrating steps involved in accordance with one method of the present invention.

FIG. 3 is a schematic diagram illustrating process flow in accordance with one embodiment of one aspect of the present invention.

### DETAILED DESCRIPTION OF THE PREFERRED EMBODIMENTS

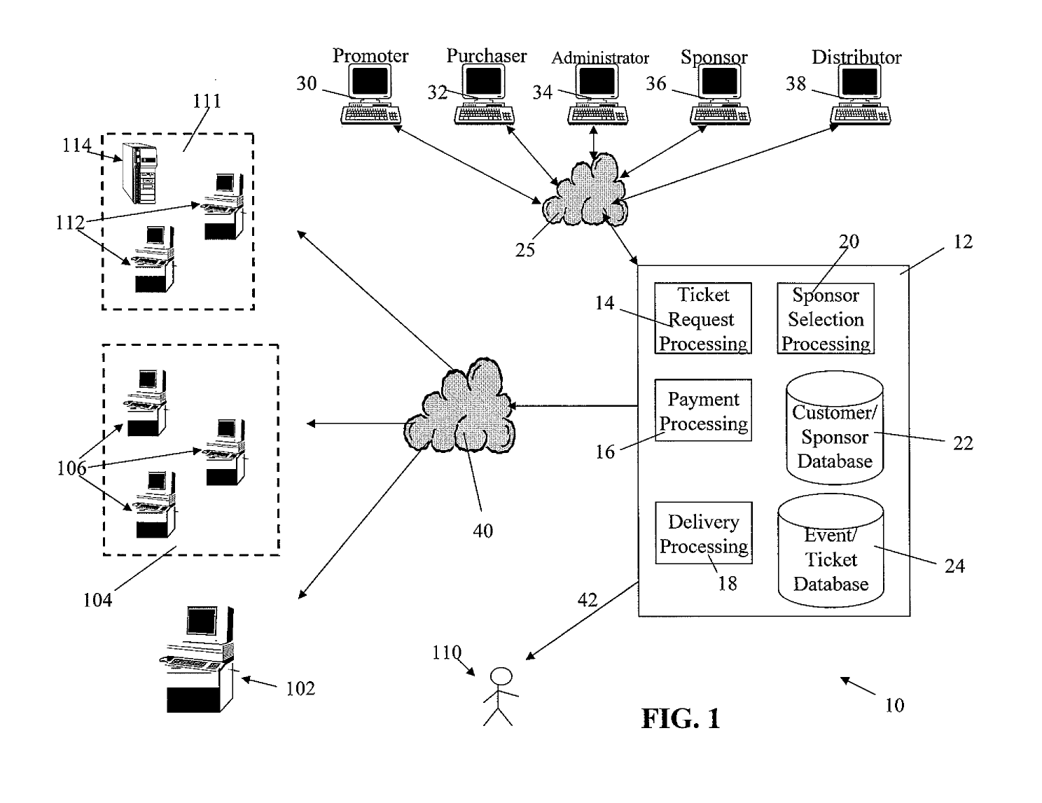

As shown in FIG. 1, the present invention provides, in part, a computer-implemented system 10 for event ticket management and delivery. The system 10 includes a central management and distribution processor 12 having one or more components for facilitating event ticket request processing 14, ticket payment processing 16, ticket delivery processing 18 and sponsor selection processing 20. The central processor 12 further includes one or more databases, such as customer/sponsor database 22 and event/ticket database 24. Processor 12, components 14, 16, 18 and 20, and databases 22 and 24 operate in a computerized environment, incorporating computer programs, routines processing capabilities, memory and communications sufficient to operate the present invention as described herein. Events contemplated by the present invention include, by illustration and without limitation, entertainment, sports, political, social and other limited access events; limited capacity locations such as museums, parking facilities, parks, recreational facilities, trails and other places or businesses, for example; and limited access presentations, such as web streams, for example.

Ticket request processing component 14 operates so as to receive ticket requests from one or more sources (e.g., ticket purchasers, administrative personnel), and access the ticket database 22 to determine whether the requested tickets are available. If the tickets are not available, the ticket request processing component responds to the requester accordingly, and can offer optional substitutes for the user's request. In one embodiment of the present invention, current and past information pertaining to the ticket requester is stored in customer database 24, such that the ticket request processing component can make more informed suggestions to the requester when the desired tickets are not available. An appropriate data mining component (not shown) can be provided in accordance with one embodiment of the present invention to facilitate such functions.

If the requested tickets are available, ticket request processing component can advise the requester accordingly, and can further advise the requester of up-sale and cross-sale opportunities as desired. For example, if the ticket requester is seeking lawn seats for a music event at an indoor-outdoor amphitheater, the ticket request processing component can inform the requester that the desired seats are available, and can further advise the requester that indoor seats are also available at a slightly higher price, or that picnic dinners or t-shirts are available at additional cost (up-sale). The ticket request processing component can also advise the requester that entertainment discounts at a local movie theatre may also be obtained after purchasing the tickets (cross-sale), for example. As with the example above where the requested tickets are not available, the present invention can employ database 24 and data mining component to determine the most relevant up-sale and cross-sale opportunities for the ticket requester based upon information stored or obtained about the ticket requester.

Once the ticket requester is informed that the requested tickets are available, the ticket payment processing component 16 can interact with the requester to process payment. If the requester pays for the tickets at the time of ordering, ticket payment processing component 16 can accept the form of payment information (e.g., credit card, debit card) and payment details (credit card number, expiration date, etc.) and can process payment through separate connection with banks and further payment processors (not shown) as is known in the art. Once payment has been successfully processed, the requester will then interact with ticket delivery processing component 18 to arrange for ticket delivery and/or pickup.

The ticket delivery processing component 18 offers options to the ticket purchaser for delivery of the tickets, and provides information processing and ticket processing instructions according to the purchaser's selection. In one embodiment of the present invention, the ticket purchaser can be offered the opportunity to receive physical delivery of the ticket(s) to a purchaser-specified address. This option can be fee-based or non-fee based. In this embodiment, the ticket delivery processing component 18 processes the selection and prints the ticket(s), such as through an appropriate ticket printing program and printer, for mailing to the purchaser 110 as indicated at 42 using procedures known in the art. As an alternative, the ticket delivery processing component can electronically communicate ticket information to the user via network 25, so that the purchaser can print the ticket using a computer and printer capable of such printing at the purchaser's location. In one embodiment of the present invention, the processing component 12 manages only physical distribution of physical tickets. In another embodiment of the present invention, distribution component does not manage physical tickets, but manages electronic representations of the tickets.

Alternatively, or in addition, the ticket purchaser can be offered the opportunity to pick up his or her ticket(s) at a remote location that may be nearer to his or her home or the event venue, for example. To accommodate the option where the purchaser elects to pick up tickets at a remote location, the present invention can provide for a staffed ticket station whereby an individual associated with a ticket distributor can meet the ticket purchaser and deliver the tickets. The tickets can be mailed to the ticket station in physical form, or the ticket delivery processing component can communicate the ticket information to the station where a local printer and/or computing system prints out the tickets for the purchaser. The ticket purchaser can be required to show valid identification in order to authenticate himself or herself to the ticket staff person.

In another embodiment, the present invention can provide one or more isolated and un-staffed kiosks at the remote location (e.g., 102, 104 or 111) for ticket delivery to the ticket purchaser. Kiosks can be at or near a point-of-sale (POS), for example, and can be integrated with a POS device in one embodiment of the present invention. The ticket kiosks can be provided with pre-stored ticket stock inside the kiosk. Then, once the ticket purchaser has requested ticket pickup at the selected kiosk, a kiosk processor will receive instructions via ticket delivery component over network 40 to print the ordered ticket(s) for the ticket purchaser upon the ticket purchaser arriving at the kiosk and providing suitable authentication. In one embodiment of the present invention, the present invention authenticates the purchaser by requiring the purchaser to swipe the credit card that had been used to purchase the tickets through central processor. In another embodiment of the present invention, the purchaser can use a name and/or password using a kiosk interface. In a typical embodiment of the present invention, the kiosk interface operates on a computer equipped with a keyboard or, alternatively, a touch screen monitor that allows the user to use touch-sensitive controls to enable system interaction via fingertip. In one embodiment of the invention, the kiosk interface is a browser-based interface that doubles as a purchaser interface and that may be deployed anywhere network connectivity exists. It will be appreciated that the kiosk can be provided with suitable audio and video capabilities to offer further entertainment and/or purchasing opportunities for the ticket purchaser. It will further be appreciated that the kiosk can be provided with coupons or other consumer items that can be presented to the purchaser to entice the purchaser to shop at the retail store in which the kiosk resides, or even other nearby retail stores. In one embodiment of the present invention, the kiosk can hold multiple ticket card stocks to enable different types of tickets to be printed. This capability can be provided for personal tastes of the promoter or purchaser, or to enable additional security features to be imprinted on more advanced ticket types, for example.

It will be appreciated that a variety of kiosk arrangements can be provided in accordance with different embodiments of the present invention. For example, as shown in FIG. 1, an isolated kiosk 102 can be provided at a ticket delivery location such as a sponsor's retail store or a ticket distributor outlet. A group of kiosks 106 can be provided at a single large retail store 104 or at a plurality of individual retail establishments associated with one or more retailers. Even further, another retailer 111 may provide multiple kiosks 112 for in-person ticket delivery and a computer 114 for further computerized delivery to downstream ticket vendors and/or external kiosks, for example.

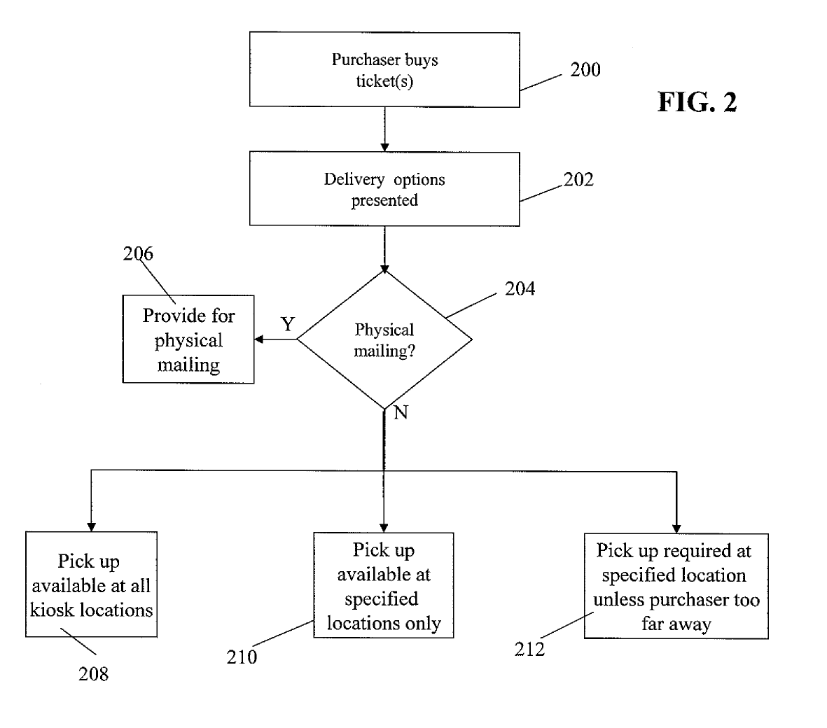

In one embodiment of the present invention, the ticket delivery processing component 18 can take the purchaser through decision processing according to the flow chart illustrated in FIG. 2. As shown therein, one or more tickets are purchased as at step 200. Then, the ticket delivery processing component offers the purchaser different delivery options as at step 202. If the purchaser elects physical mailing at point 204, the tickets are then mailed to the purchaser's specified address (or electronically delivered for local printing) as at 206. If the purchaser does not elect physical mailing, then the delivery processing component can offer the purchaser the options to pick up the tickets at any available kiosk as at 208 or specified kiosks as at 210. In one embodiment of the present invention, all kiosks as represented at element 208 include all kiosks associated with an event promoter, and specified kiosks as represented at element 210 include only kiosks associated with an event sponsor. For example, if MusicToday™ is an event promoter for a concert, the user can select the option at 208 to pick up tickets at any available MusicToday™ kiosk. If Home Depot™ is a sponsor, the user can select the option at 210 to pick up tickets at any available Home Depot™ kiosk. As another alternative, the ticket delivery processing component can offer the user the option to pick up the ticket(s) at certain delivery locations unless their mail delivery will be to a zip code or location more than a specified distance (e.g., 15 miles) from a designated sponsor, as indicated at 212. This option is helpful for purchasers who live in highly remote places who may find it inconvenient to travel to a specified kiosk location.

As a further alternative, kiosks associated with the present invention can be affiliated with a system provider and/or operator of the distribution processor of the present invention. For example, if the present invention is operated by Company XYZ and there are no sponsors and the event promoter has no associated kiosks, Company XYZ can employ its own kiosks for ticket distribution.

It will be appreciated that the options offered to a potential ticket purchaser can be combined or narrowed using one or more of the above options (or other options) depending upon the objective of the ticket promoter. For example, the present invention can be designed such that only physical mailing of tickets (including any of U.S. Mail, UPS™, DHL™, and/or FedEx™, for example) or home printout is an available delivery mode. Alternatively, the present invention can be configured such that the purchaser is given the option to pick up the ticket at a promoter's kiosk location or at a sponsor's kiosk location only. It will be appreciated in such embodiments that the purchaser can be given the option to review locations and lists of kiosks in order to determine the most convenient kiosk location for the purchaser.

In addition to the ticket processing components described above, the present invention can further include a sponsor selection processing component 20. Event sponsors can be retailers, for example, who wish to be associated with particular events for which ticketing is managed by the system of the present invention. As an example, Home Depot™ may wish to associate its brand with NASCAR™ races, so it may choose to request sponsorship of one or more events. Sponsorship can take many forms, including traditional sponsorship such as signage, advertising time and space, and promotional benefits at on-site retailer locations, as well as non-traditional forms such as provided in accordance with the present invention. For example, a retailer sponsor can be represented as at 104 in FIG. 1, and can be provided with ticket kiosks 106 at one or more retailer locations, wherein the kiosks are capable of printing event tickets for the specific event for which the retailer has acquired sponsorship rights. Thus, when ticket purchasers proceed to pick up their tickets at the retailer kiosk, the retailer can hope to experience additional foot traffic in their stores for potential sales as described above. In one embodiment of the present invention, the ticket management system is adapted to receive an event sponsor selection of an event for which an event sponsor would like to distribute keys, as described in more detail below.

The sponsor selection processing component 20 can assist the sponsor in selecting events to sponsor as well as in managing the sponsor's ticket and/or key distribution options in accordance with the present invention. For example, a nationwide retailer such as Home Depot™ may not wish to incorporate a nationwide system of kiosks for an event in Omaha, Nebraska. Rather, Home Depot™ will likely want the option to activate kiosks for ticket and/or key deliveries for such an event in and around the Omaha area only. Additional sponsor-associated aspects of the present invention are described in more detail below.

As further shown in FIG. 1, central processor 12 is also provided with a customer/sponsor database 22 and an event/ticket database 24. Event/ticket database can store all ticket information for all events managed by the system of the present invention. It will be appreciated that the distribution processor can manage ticketing for multiple events at the same time. Customer/sponsor database 22 can store information pertaining to customers/purchasers of tickets using the system of the present invention as well as sponsor information. Event selection history and other information that indicates particular preferences of customers and sponsors can be sought, for example, so that the present invention can provide better suggestions and targeted marketing to these user types in the future, as described above.

While not shown, processor 12 of the ticket management system can include programming for executing further functions, such as, for example, establishing an on-sale beginning and end time that defines when tickets will be available for sale. The on-sale beginning time identifies when tickets will first become available for sale, and the on-sale end time identifies when tickets will no longer be available for sale. In many instances, there will be no established on-sale end time because tickets can be sold up to and during the actual date and time of the event.

Various user types can interact with the central processor 12 as shown in FIG. 1. For example, event promoters 30, ticket purchasers 32, system administrators 34, sponsors 36 and distributors 38 can interact with the central processor in various embodiments of the present invention. In one embodiment of the present invention, these actors can use computer interfaces connected via network 25 to central processor as shown in FIG. 1. The network 25 can be, for example, a telecommunications network, a local area network (LAN), wide area network (WAN), metropolitan area network (MAN), private network, or publicly accessible network such as the Internet.

Event promoters 30 can be entities such as NASCAR™, which promotes its own professional car races, or music promoters managing a tour schedule for their clients, for example. Such promoters might interact with the central processor to indicate options or commitments for event tour dates at specific venues, such that central processor can manage the ticket ordering, processing and delivery. In one embodiment of the present invention, an administrator component 34 interacts with the central processor on behalf of the event promoter, who can interact with administrator via in-person meetings, telephone or other traditional business formats.

Potential ticket purchasers 32 can interact with central processor 12 via network connection such as the Internet, for example, in order to request tickets for desired events. It will be appreciated that the available ticket offerings can be provided to potential purchasers in advance through customary advertising and web sites, for example, such that the purchaser will know his or her desired ticket purchase request at the time of interacting with central processor. As with event promoters, ticket purchasers may also interact with an administrator via telephone or in-person in order to request tickets. The administrator in this embodiment would then interact with central processor through interface 34 to determine the availability of desired tickets and to process ticket ordering and payment.

Event sponsors can also interact with central processor via network 25 using a computer interface 36 for the purposes described above, i.e., advertising and providing kiosk locations for ticket delivery in order to promote foot traffic. In lieu or in addition to interacting with the central processor via interface 36, event sponsors can also interface with the ticket management system of the present invention indirectly. This can be through business meetings, phone calls and other traditional meeting formats, whereby a system representative reaches a business agreement with the sponsor and necessary information pertaining to the business relationship is received, recorded and established with the central processor via administrative interface 34.

Event sponsors can request full or partial sponsorship using the system of the present invention. Sponsorships for events are often divided among multiple parties in order to maximize revenues for the event organizer and venue as well as to reduce the sponsorship costs to any individual sponsor. Accordingly, sponsors may request a partial sponsorship in accordance with the present invention so as to obtain the right to distribute a percentage of the overall tickets and/or keys distributed for the event. For example, if Company A, Company B and Company C wish to share sponsorship for an event equally, then each would be entitled to associated ⅓ of the purchased tickets and/or keys with its preferred delivery option. Company A may desire to sell all of its tickets through a single retail kiosk, Company B may desire to sell all of its tickets through multiple kiosks at different locations and Company C may desire to sell all of its tickets through the mail with supplemental flyers advertising its products. The present invention can accommodate all three wishes while ensuring that ticket delivery options presented to the purchasers are appropriately managed. For instance, if 33% of the tickets available are purchased by purchasers who all prefer to have the tickets mailed to them, then Company C's allocation of tickets would be consumed, and the ticket delivery processing component would be updated to reflect that purchasers could no longer be offered the option to receive tickets by mail for that event. In this way, Company A and Company B's sponsorship preferences would be maintained.

In one embodiment of the present invention, an event sponsor can submit a request to distribute all tickets and/or keys at its remote kiosks. All event sponsor requests can be received by the sponsor selection processing component 20 associated with central processor (e.g., via event sponsor interface or administrative user interface) and processed accordingly. In one embodiment of the present invention, sponsor selection processing component 20 includes programming to allow one or more sponsors to bid a value for being either an exclusive or non-exclusive sponsor of a specified event or event package. In this embodiment, central processor can manage an auction for the right to sponsor the event. Once bids are received, the sponsor selection processing component can determine one or more event sponsor winners, and can thereafter associate all or a portion of tickets and/or keys for the event with the winning sponsor(s). Ticket and/or key distribution can then follow according to the distribution option preferences of the winning sponsor(s).

One or more distributors 38 can also interact with central processor using a separate computer interface as shown in FIG. 1. A distributor may be a retail ticket outlet or event venue outlet, for example, that may or may not have a sponsorship for the event. Distributors can interact with the system of the present invention in order to determine which events and the number of tickets and/or keys distributor will be distributing, the timing of delivery and the allocation among different outlets, for example.

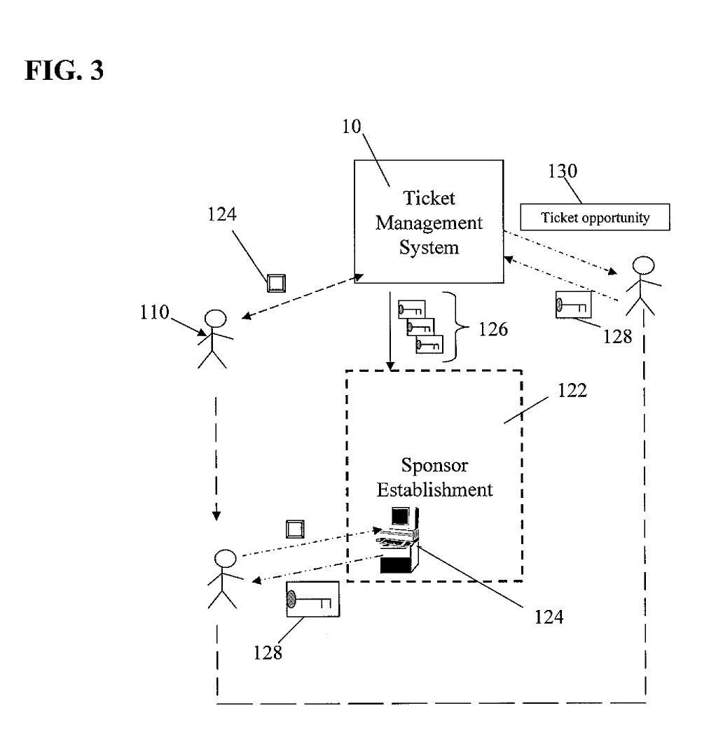

With regard to the aspects of the present invention dealing with keys, as shown in FIG. 3, the ticket management system 10 can provide (such as through processor 12, for example) for the issuance of keys 126 for use in driving pre-sales activities for different entities, such as sponsoring retail establishments, for example. A potential ticket purchaser 110 is provided with and/or has an identifier 124 that can be registered with the ticket management system. The identifier can be, for example, a user name and/or password, a personal identification number (e.g., code, alphanumeric combination), a transaction card (e.g., credit card, debit card, smart card, etc.), serial number, barcode, magnetic stripe, e-mail address, biometric identifier and/or any similar item used in commerce to identify individuals. In one embodiment of the present invention, the ticket management system issues the identifier to the individual 110.

Once an individual has a registered identifier, he or she can then seek a “key” 126 in order to have a chance at a ticket opportunity associated with a ticket sales event. The ticket opportunity can be any of several different opportunities, including, for example, (1) an option to purchase one or more tickets for an event on or after tickets are made available for sale, (2) priority access to purchase one or more tickets for an event on or after tickets are made available for sale, (3) the option to purchase one or more priority seating tickets on or after tickets are made available for sale, (4) an entry into a random drawing where the ticket management system determines, by a random selection event, whether the potential purchaser is entitled to purchase one or more tickets for an event once tickets are made available for sale, (5) an option to purchase one or more tickets for an event at a discounted price once tickets are made available for sale and (6) a limited capacity opportunity associated with the event. The limited capacity opportunity can be, for example, special upgrades (e.g., for better reserved seating), hospitality associated with the event, reserved parking, meeting with the event attraction personnel and similar opportunities.

Keys can be distributed in several ways and by different entities. For example, an artist, sponsor or promoter can distribute keys. In the case of a sponsor such as a “bricks and mortar” retailer, for example, keys can be distributed at one or more computers and/or kiosks 124 physically located on-site at the retailer's store as illustrated in FIG. 3, which can drive more foot traffic into the store, even though the store is not selling tickets to the event and even though the store is not the venue for the event. In other cases, keys can be distributed online via the Internet to a potential ticket purchaser's computer. The key can be delivered via email, computer/video/television screen, on a printed receipt, on a card, and other similar ways. In the case of physical keys, the ticket management system processor can, for example, instruct a machine to print the key(s) centrally. Alternatively, the ticket management system can send key information to another location (e.g., sponsor establishment) for local conversion to a physical key. A virtual key can be used instead of a physical key for purely online transactions, for example. In one embodiment of the present invention, keys are not distributed online until a potential ticket purchaser has made a commitment or otherwise provided something in return, such as, for example, watching a commercial for a product or service offered by a sponsor. In yet another embodiment of the present invention, the potential ticket purchaser must physically travel to a kiosk and also view a commercial at the kiosk before receiving a key.

Upon accessing the kiosk/computer and its associated interface (e.g., touch screen monitor, display monitor with keyboard and mouse, microphone, camera or other known human-to-computer interface), the potential ticket purchaser 110 can be prompted to provide his or her identifier 124 via the interface in order to receive a key 128 that is then associated with the provided identifier 124 by the ticket management system for purposes of authentication and record-keeping. In one embodiment of the present invention, the computer and/or kiosk is not in communication with the ticket management system, but acts as a standalone terminal that simply issues keys upon presentment of a suitable identifier.

In one embodiment of the present invention, an unlimited number of keys can be distributed, even though the event for which tickets are to be sold is a limited capacity event. In such a case, the keys could not all lead to ticket purchase opportunities because there would be a risk that potential ticket purchasers who believed they were entitled to a ticket based on the key would not actually receive a ticket.

As described above, the keys 126 can be distributed electronically or in physical (e.g., paper) format, for example, from the ticket management system to the distributor. In addition to establishing a ticket on-sale beginning and end time, the ticket management system can establish a time window during which keys can be distributed and/or redeemed for ticket opportunities. In many cases, the key distribution/redemption window will begin and end before ticket sales for a given event are begun. Further, the ticket management system can activate the key to allow the key user to access the ticket sale process and use the ticket opportunity during the ticket sale period. In one embodiment of the present invention, potential ticket purchasers can be restricted from making a ticket purchase or can have ticket access limited in some way unless they provide a key corresponding to the event. In a further embodiment of the present invention, once the individual enters their identifier, no key is actually transferred to the individual, but rather the ticket opportunity is automatically registered with the ticket management system and associated with the individual.

Once a key is issued, the individual 110 can then use the key 128 with ticket management system 128 in order to receive a ticket opportunity 130. The individual can “use” the key 128 by inputting the key and/or key information into a user terminal that is connected to ticket management system 12. For example, the user can hand a physical embodiment of the key to a retail ticket clerk who then enters information associated with the key into a retail terminal connected by a network to the ticket management system. If the key is verified, a ticket opportunity is returned to the clerk, who can then hand the ticket opportunity to the potential ticket purchaser 110. Alternatively, the individual 110 can access the ticket management system through an Internet web site associated with the ticket management system. It will be appreciated that the key and ticket opportunity can be represented physically or electronically. For example, if a potential ticket purchaser uses a smart card as his or her identifier, the card can be read by a retailer terminal (e.g., kiosk) in order to recognize the individual to the system. If the individual is entitled to a key, the terminal can then write the key to the memory of the smart card. Later, when the key is read by a user terminal connected to ticket management system, the ticket management system can then write the ticket opportunity to the memory of the smart card. The user can then determine what the ticket opportunity is by reading the smart card with a suitably equipped computer. The user can also use the ticket opportunity by sending it and/or registering it with the ticket management system.

It will be appreciated that the system of the present invention is capable of operating with one or more subsets of all of the indicated interfaces and processing components shown in FIG. 1, and subset embodiments are intended to be encompassed as aspects of the present invention. It will be appreciated that interfaces can include wireless devices, standard personal and laptop computers. The central processor 12 can incorporate web servers and application servers operable over a variety of operating systems, including Windows™, Linux™ or Unix™ operating systems, as well as various types of commercially available databases, including Sybase™, Oracle™, Informix™, IBM™ and Microsoft SQL™ and MySQL™, for example.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example.

The invention may be embodied in other specific forms without departing from the spirit or essential characteristics thereof The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. A method, comprising:
establishing an on-sale beginning time wherein tickets for an event will become available for sale;
prior to the on-sale beginning time:
reading, by a computer, an identifier provided by a potential ticket purchaser;
issuing a key by the computer to the potential ticket purchaser; and
submitting the key to a ticket management system for a ticket opportunity for the event.

2. The method of claim 1 wherein the event is a limited access event.

3. The method of claim 1 wherein the key is one from an unlimited supply of keys.

4. The method of claim 1 wherein the ticket opportunity comprises granting, by the ticket management system, the potential purchaser with the option to purchase one or more tickets for the event on or after the on-sale beginning time.

5. The method of claim 1 wherein the ticket opportunity comprises granting, by the ticket management system, the potential purchaser with priority access to purchase one or more tickets for the event on or after the on-sale beginning time.

6. The method of claim 1 wherein the ticket opportunity comprises granting, by the ticket management system, the potential purchaser with the option to purchase one or more priority seating tickets for the event on or after the on-sale beginning time.

7. The method of claim 1 wherein the ticket opportunity comprises initiating, by the ticket management system, a random selection event for determining whether the potential purchaser is entitled to purchase one or more tickets for the event on or after the on-sale beginning time.

8. The method of claim 1 wherein the ticket opportunity comprises granting, by the ticket management system, the potential purchaser with the option to purchase one or more tickets for the event at a discounted price on or after the on-sale beginning time.

9. The method of claim 1 wherein the ticket opportunity comprises granting, by the ticket management system, the potential purchaser with a limited capacity opportunity associated with the event.

10. The method of claim 1 wherein the identifier is an identifier from the group consisting of:
transaction card, personal identification number, e-mail address, biometric identifier.

11. The method of claim 1 wherein, during the step of issuing a key, the computer and the potential ticket purchaser are located within a physical retail establishment.

12. The method of claim 1 wherein the step of issuing a key includes delivering the key from the computer over a network to a computer operated by the potential ticket purchaser.

13. The method of claim 1 wherein the step of issuing a key includes issuing a plurality of keys and associating the keys with the identifier.

14. The method of claim 1 wherein the step of issuing a key is restricted to a time period that begins and ends before the on-sale beginning time.

15. The method of claim 1 including the further steps of:
providing a plurality of remote physical ticket distribution kiosks in communication with the ticket management system;
providing a ticket purchaser interface for receiving a ticket purchase order and a kiosk identifier from a potential ticket purchaser, and communicating the purchase order and kiosk identifier to the ticket management system; and
delivering, by the distribution processor, one or more tickets corresponding to the purchase order to a kiosk associated with the kiosk identifier.

16. A system, comprising:
a ticket management system including a processor for establishing an on-sale beginning time wherein tickets for an event will become available for sale;
a computer interface for reading an identifier provided by a potential ticket purchaser and issuing a key to the potential ticket purchaser prior to the on-sale beginning time; and
an interface associated with the ticket management system for receiving the key and presenting a ticket opportunity for the event issued by the ticket management system prior to the on-sale beginning time.

17. The system of claim 16 wherein the computer is not in communication with the ticket management system.

18. The system of claim 16 wherein the computer is physically located on the premises of a retail establishment that is not the venue for the event.

19. The system of claim 16 wherein the ticket opportunity is an opportunity from the group consisting of: an option to purchase one or more tickets for the event on or after the on-sale beginning time; priority access to purchase one or more tickets for the event on or after the on-sale beginning time; the option to purchase one or more priority seating tickets for the event on or after the on-sale beginning time; determining, by a random selection event, whether the potential purchaser is entitled to purchase one or more tickets for the event on or after the on-sale beginning time; an option to purchase one or more tickets for the event at a discounted price on or after the on-sale beginning time; and a limited capacity opportunity associated with the event.

20. The system of claim 16 wherein the ticket management system is adapted to receive an event sponsor selection of an event for which an event sponsor would like to distribute keys.
